(19) United States
(12) Patent Application Publication
(10) Pub. No.: US 2005/0243173 A1
(43) Pub. Date: Nov. 3, 2005

(54) Portable modular inspection-surveillance system

(76) Inventors: Bob Levine, Hauppauge, NY (US); John A. Kennedy, Hauppauge, NY (US)

Correspondence Address: Lee Grosskreuz Hechtel, Esq., 2 Meroke Trail, Port Jefferson, NY, 11777, US

(21) Appl. No.: 10/838,033

(22) Filed: May 3, 2004

(51) Int. Cl. H04N 7/18

(52) U.S. Cl. 348/164; 348/143

(57) ABSTRACT

A portable, modular inspection-surveillance system with an open architecture that may be dynamically configured in the field as conditions change and dictate, a kit for an inspection-surveillance system, and methods of use.

### TECHNICAL FIELD

This disclosure relates to a portable, modular inspection and/or surveillance system. More particularly it relates to a portable, modular inspection-surveillance system which can be readily and immediately configured and re-configured as conditions in the field require and demand.

### BACKGROUND OF RELATED ART

Each time law enforcement and military personnel are called to duty; the situation they face will be uncertain or even unknown until they arrive on the scene. In the wake terrorist attacks, both in the United Sates and abroad, each call to duty may present a dangerous and dire situation, such as threats of terrorist bombings, terrorist attacks leaving collapsed building structures with possible survivors inside, or hostage taking, which can only be apprised on the scene. In addition, law enforcement and military personnel keep the safety of bridges and tunnels, as well as commercial and government properties, under constant surveillance, operating in a continuous state of flux. For example, a commercial flight lands with in-flight passenger problems, a truck with unknown cargo and an uncooperative driver attempts to enter a tunnel or bridge toll plaza, or a suspicious shipment arrives at a customs border checkpoint. In each instance, the law enforcement or military personnel must respond to very different circumstances to gather real-time information while protecting lives and, wherever possible, property.

Law enforcement and military personnel presently employ inspection and surveillance tools that are constructed to be fixed in a permanent configuration. These permanently configured tools can serve in very specific and limited roles as their designs permit, but are not flexible for use as conditions evolve rapidly in the field and/or the unexpected arises.

Therefore, an inspection-surveillance system that provides flexibility to configure equipment to immediately meet the demands of the situation would be desirable. Law enforcement or military personnel would be readily equipped to evaluate, manage, and diffuse the situation. For example, audio and visual information would be taken from the inside of the plane to determine the level/type of response necessary to protect the passengers; the truck would be monitored for sound in inside the trailer and inspected visually for any unusual equipment or variations; the suspicious shipment would be inspected for any visually gleaned information as well as sound and smells which may be emitted from the shipment, while the customs official operates the inspection equipment from a safe distance or form behind a protective barrier.

### SUMMARY

This disclosure relates to a portable, modular inspection-surveillance system, which is designed as open architecture system that can be readily and immediately configured and re-configured as conditions in the field require and demand based upon the variables of environment and use requirements.

The modular inspection-surveillance system which allows reconfiguration of a number of components to gather data including a camera head, which may have light emitting sources; a body, which may be composed of non-conductive material, and having a cable assembly disposed therein; a display module having a video image viewing screen; a housing having an internal battery; and connectors having electrical and mechanical properties. At least these components are operatively coupled to form a modular inspection-surveillance system that is flexible and adaptable to any field requirement. The modular inspection-surveillance system may take the form of a kit of modular components. The components may be reconfigured as field conditions require or demand.

A method of covertly inspecting an area is disclosed which includes adjusting a camera head's spectral response and illumination bands, attaching the camera head to an operatively coupled body that is flexibly positioned to view the area, and inspecting the area for information.

### BRIEF DESCRIPTION OF THE DRAWINGS

FIG. 1 is a perspective view of a configuration of the modular inspection-surveillance system in use for a covert surveillance.

FIG. 2 is a schematic drawing of the telescoping body and electronic cable assembly.

FIG. 3 is a perspective drawing of a configuration of the inspection-surveillance system as a modular trolley system.

FIG. 4 is a perspective drawing of a configuration of the inspection-surveillance system using a fixed-length, rigid body with the false-wall detection module.

FIG. 5 is a perspective drawing of a configuration of the inspection-surveillance system with a fixed-length body having a flexible portion operatively coupled to an IR camera head for search and rescue work.

### DETAILED DESCRIPTION

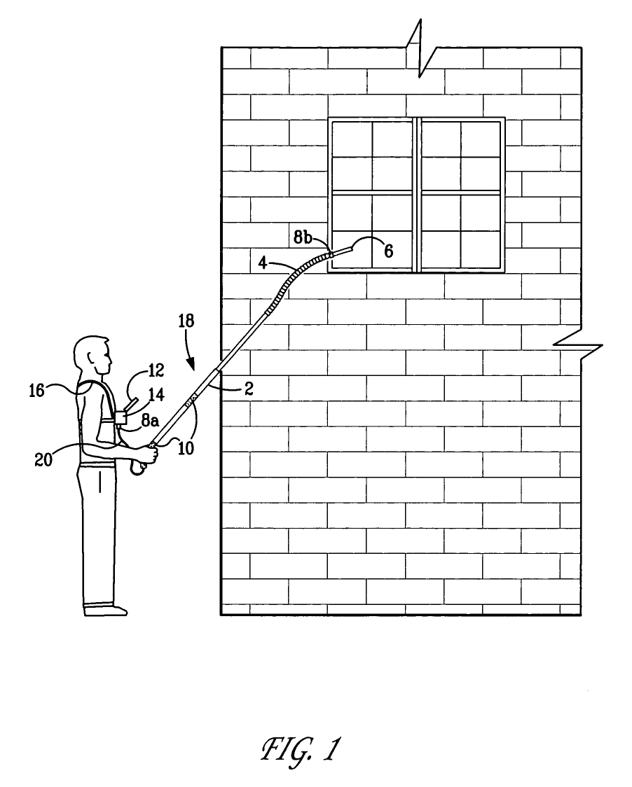

Referring to FIG. 1, a configuration of the inspection-surveillance system 18, is shown with a telescoping body 2 formed of submersible, non-conductive materials and having a semi-hollow interior (not shown) along the length of the telescoping body 2. In alternative configurations, the body of the inspection-surveillance system can take other forms, such as, a fixed-length body having a flexible portion 44, a fixed-length, rigid body 42, a semi-rigid cable or a trolley 26. The semi-hollow interior protects and guides the electronic cable assembly 20 which conducts power and audio/visual information. The telescoping support body 2 also has a flexible forward portion 4, which can be formed of submersible, non-conductive materials. The flexible forward portion 4 has a bend radius of at least 2.5 inches per foot. The power source/control panel housing 14 (the “Housing”) 14 is operatively coupled to the telescoping body 2 at end opposite the flexible forward portion via at least one connector 8A. The Housing 14 is surrounded with a waterproof covering. All connectors 8 are readily detachable, can provide single- or multi-input connections, are preferably water-proof and provide both electrical and mechanical support, such as a pin connector, a jack-and-plug connector, and the like. The Housing 14 includes a control panel (not shown) for at least the audio, visual, dimmer, and power/on/off controls, including power controls for voltage directed to functions such as illumination, camera mode switching, pan/zoom/tilt adjustments, audio or video receiver channel selection and/or receiver tuning adjustment. The Housing 14 also includes an internal rechargeable direct current (“D.C.”) battery of at least 7 volts that can be supplemented with, or substituted by, external D.C. batteries.

As shown in FIG. 1, the audio-visual display module 12 is operatively coupled to the Housing 14 via at least one connector 8. The display module includes a viewing display screen, which can be an LCD display screen or any lightweight display screen, to allow the user to view images produced by the camera head 6. The display module 12 includes its own set of controls for the display screen, which adjusts the brightness, contrast, tint and color when a color camera head 6 is in use. The display module 12 also has a power switch allowing the user to power down the display module 12 independently when only audio information is necessary or to avoid glare, reflection, or light emission when it could compromise the user's security or location in the field. As shown in FIG. 1, the display module is operatively coupled to the Housing 14 can be used in combination with a harness 16 that may be worn by a user allowing the user immediate access to the control panel (not shown) and easy maneuverability in the field. The display module 12 can also take other forms such as a small screen or eye piece to be positioned before the user's eye or face, or large stand-alone display module 38, which can be remotely positioned away from the inspection-surveillance system and monitored by many viewers.

A camera head 6 is operatively connected to the flexible forward portion 4 of the telescoping support body 2 via at least one connector 8 to produce video images on the display module 12 or a remotely positioned large stand alone display module 38. The camera heads 6 can be submersible, or weatherproof for use in bad weather conditions. The camera head 6 can, if desired, include at least one light that may emit illumination bands of a plurality of different wavelengths, such as visible spectrum, ultraviolet (“UV”) and/or infrared (“IR”) and provide varying Lux units of illumination. In one embodiment, the camera head 6 can include a plurality of lights. The light can be light-emitting diodes (“LEDS”) or any light source that is light weight and can readily be mounted in the camera head 6. The camera head 6 may also have spectral response that includes a plurality of frequencies such as bands of the visible, and the invisible electromagnetic spectrum. The camera head may actively or passively generate an image using reflected electromagnetic energy when ambient lighting levels are not sufficient to create a usable video image. The camera head 6 lenses can have varying, adjustable focal lengths, varying field of views (“FOV”), i.e. wide angle lens, macroscopic or microscopic lenses, and/or produce images in color or black and white. The camera head 6 can also include an audio module that can have acoustical transducers with high or low gain characteristic and can include audio processing, such as, for example, compression or filtering to enhance the audio signal. The audio signal can heard by the user via the Housing 14, a head set (not shown), and/or can be remotely transmitted via a radio frequency (“RF”) audio transmitter 36. In addition, the camera head 6 can include an olfactory module (not shown) that can detect a variety of programmed chemical scents. Because the inspection-surveillance system is entirely modular, any embodiment of the camera head 6 that can be operatively coupled with any body form may be employed as desired to interface with the display module 12 and the Housing 14.

In another embodiment, the camera head 6 can be a multi-mode video camera (not shown) that allows the user to select between several different video technologies that housed in a common camera head while the inspection-surveillance system is in use, and can be used with any configuration of the inspection-surveillance system. The multi-mode camera has at least two video cameras of different technologies grouped together in a common housing to form a single camera head, or multiple camera heads of different technologies can be operatively coupled to a multi-input camera connector 8A. The multi-mode camera is operatively coupled to the electronic cable assembly 20 in the telescoping support body 2 via the connector 8A. Each multi-mode camera includes two or more different video camera modules and each has unique capabilities for generating a video image, and an audio module. The different video camera modules are mounted with their respective optical lens systems trained in the same direction. The multi-mode camera is also operatively coupled to the control panel (not shown) of the Housing 14 via the electronic cable assembly, to control voltage to dim or brighten the illumination of LEDS, if present, of the multi-mode camera and select between camera modes. As with other single mode camera heads 6, the multi-mode camera can include, if desired, at least one light that may emit illumination bands of a plurality of different wavelengths, such as visible spectrum, ultraviolet (“UV”) and/or infrared (“IR”) produced by light-emitting diodes (“LEDS”) or any light source that is lightweight and can readily be mounted. The LEDs can provide varying Lux units of illumination. The multi-mode camera head also may have spectral response that includes a plurality of frequencies such as bands of the visible, and the invisible electromagnetic spectrum. The multi-mode camera head may actively or passively generate an image using reflected electromagnetic energy, when ambient lighting levels are not sufficient to create a usable video image. The lenses employed in the multi-mode camera head can also have varying, adjustable focal lengths, varying field of views (“FOV”), i.e. wide angle lens, macroscopic or microscopic lenses, and/or produce images in color or black and white.

The multi-mode camera generates video and audio signals that feed into an audio-video multiplexer circuit. The multiplexer circuit can be used to select one of various audio-video inputs from the different camera modules. The video multiplexer is controlled by an analog control voltage, which is remotely controlled by the user and the control voltage is generated by a rheostat on the control panel.

The multi-mode video camera can advantageously allow the user to immediately switch between video technologies without changing or revealing the position of the inspection-surveillance system. The multi-mode camera can interface with any other module of the inspection-surveillance system as may be required in the field.

Continuing with FIG. 1, the telescoping body 2 may also include handgrips 10, for additional grip on the telescoping body 2 and comfort of the user. In one embodiment, the handgrips 10 can be cushioned, and can be formed of an elastomeric or plastic material.

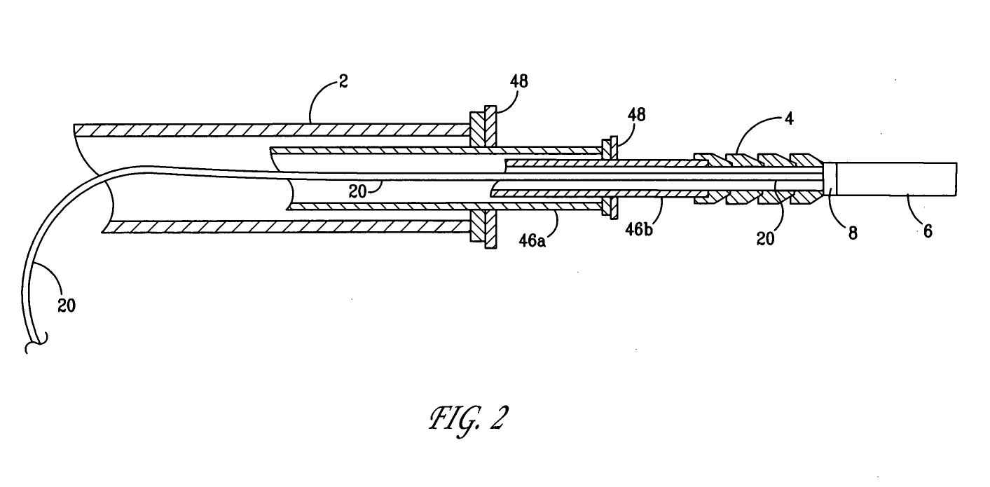

Referring to FIG. 2, a schematic drawing of the telescoping body 2, with several extensions 46a and 46b, is shown. The extensions 46a and 46b are held in place with a locking means or clamps 48. The electronic cable assembly 20 runs the length of the telescoping body 2 from the operatively connected camera head 6 or audio module (not shown) through the flexible portion 4 to the end of the telescoping body located closest to the user, and the electronic cable assembly 20 exits the telescoping body 2 as a length of cable to be operatively connected to the Housing 14. The electronic cable assembly can be run in any configuration, and can be shielded or unshielded.

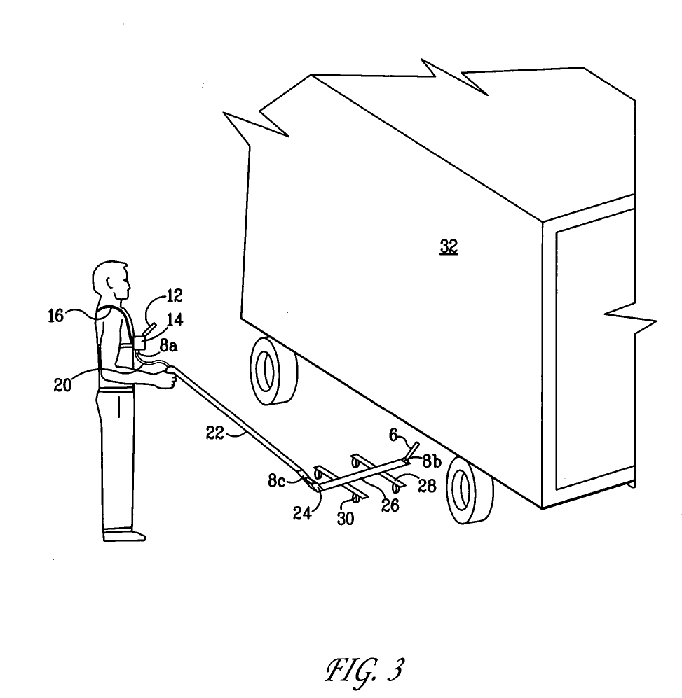

Referring to FIG. 3, a drawing of the inspection-surveillance system configured as a modular trolley system shows the inspection of a truck 32 at a security checkpoint. The user manipulates and directs the trolley 26 with a handle 22, which can function here as a handle that is operatively coupled to hinge 24 or other mechanism that can readily swivel or rotate for maximum positioning of the trolley 26. The handle 22 is operatively coupled to hinge 24 via a connector 8C and with the Housing 14 and the display module 12 via connector 8A. The trolley 26 has at least two cross bars 28, as shown in FIG. 3, that support the trolley 26, and have wheels 30, that can also be embodied as castors, which rotate at least 270+ to allow great maneuverability. A trolley 26 having one cross bar 28 or alternative designs such as circular or triangular shaped trolleys or sliding trolleys can also be employed. A camera head 6, as described above, can be operatively coupled to the trolley 26 via connector 8B. The camera head 6 may be substituted with the multi-mode camera, an audio device (not shown) and/or an olfactory device (not shown), as the situation requires in the field. The user manipulates the inspection-surveillance system to position it under the truck 32 and view the undercarriage of the truck 32, checking for explosives, hidden cargo, such as passengers, unusual compartments, narcotics or other contraband. The trolley 26 can be maneuvered to view the entire undercarriage without placing the user in immediate contact with potentially dangerous cargo, allowing a full inspection to be done with lowered risk to personnel. The trolley 26 also has the added advantage of lowering physical strain on the user by reducing repetitive motion of bending, kneeling and crawling under the truck 32.

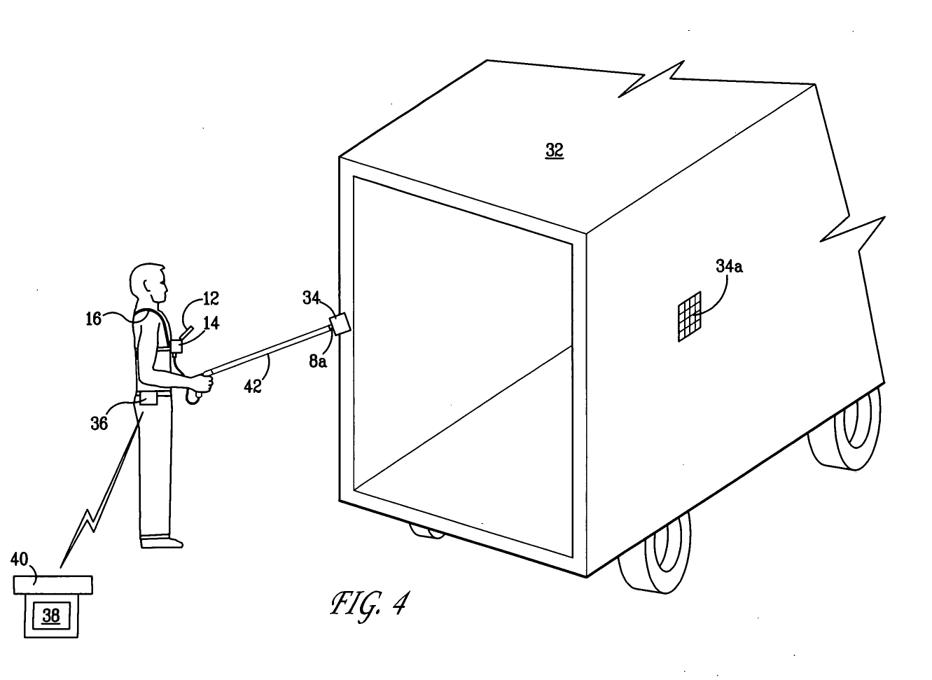

Referring to FIG. 4, a fixed-length, rigid body 42 can be operatively connected to a false-wall detection module 34, which can electronically measure the interior and exterior of a truck trailer, a cargo holding container, storage hangar, warehouse and the like. The false-wall detection module 34 includes a self-illuminating video camera, such as a camera head 6 or a multi-mode camera (not shown), which can be mounted on a fixed-length, rigid body 42, a fixed-length body having a flexible portion 44, or telescoping body 2 to allow the user to view areas that may be difficult to reach or blocked by cargo, such as a cargo area of a truck or container, storage hangar, warehouse, or the like. The false-wall inspection module 34 also includes an ultrasonic or laser rangefinder that can be remotely activated if desired and can be operatively coupled with the fixed-length, rigid body 42, or mounted with or within the camera head 6. The distance is displayed on the display module 12 and/or remotely displayed on a large stand-alone display module 38 that may be viewed by the user regardless of the position of the false-wall module 34. The distance may be indicated in metric or English units, as chosen by the user. The user positions the false-wall detection module 34 that is operatively coupled to a fixed-length, rigid body 42 in, for example, a cargo area and conducts a visual assessment using video data that is transmitted via a camera head 6 or a multi-mode camera (not shown). The user then activates the electronic range finder of the false-wall detection module 34 and positions the false-wall detection module 34 adjacent to an interior wall of the cargo area, and aims the electronic range finder at anterior section of the cargo area, and records the reading. The false-wall detection module 34 is then held adjacent to an exterior wall of the cargo area pointing to the same anterior section of the cargo area from the outside or the cargo area. A temporary reflective target 34A is a temporarily attached or positioned on the farthest exterior point of the cargo area, or can be held by a second user, to measurement the distance of the full length of the cargo bay. The interior distance and the exterior distance readings are compared to detect any significant discrepancy.

The fixed-length, rigid body 42 and the electronic cable assembly 20 can be operatively coupled with the Housing 14 and the display module 12 for immediate viewing of the audio-visual information by the user and/or remotely transmitted via the operatively coupled transmitter 36 to a remote location having a receiver 40 that can detect audio and visual transmissions and a large stand-alone display module 38 that can display transmitted video images from the inspection-surveillance system and broadcast audio data. Audio and/or visual data can be remotely transmitted to a secure location used as a command point, or can be transmitted to be assessed by personnel in addition to, or instead of, the user.

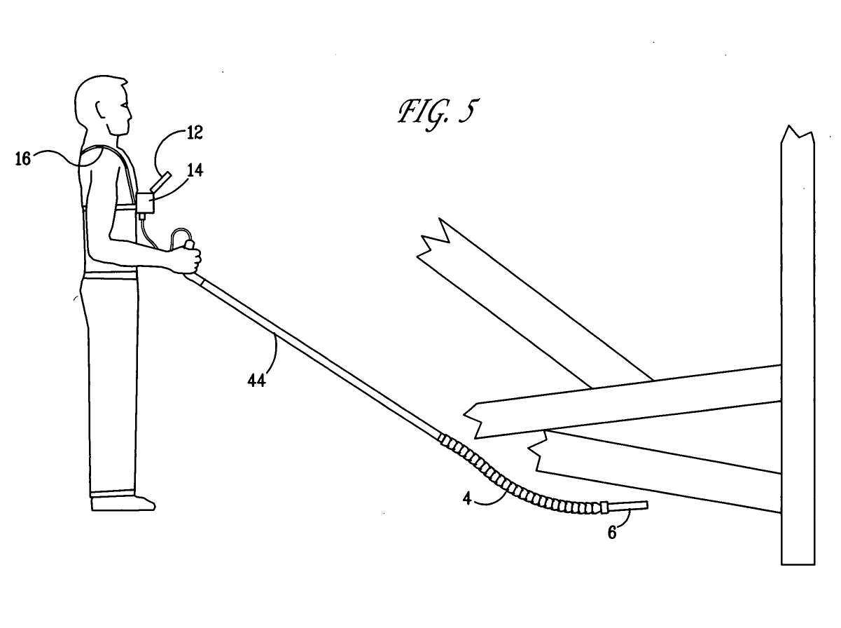

Referring to FIG. 5, a configuration of the inspection-surveillance system is shown a camera head 6 operatively coupled to a fixed-length body having a flexible portion 44, a fixed-length, rigid body 42, or a semi-rigid cable (not shown), via a connector 8. The camera head 6 can detect IR to detect heat as an indictor of survivors in collapsed building that was destroyed or attacked. The fixed-length body having a flexible portion 44 can be snaked through the remaining portions of the building structure or the rumble in search of air and space pockets that may temporarily enclose and protect trapped survivors. In an alternative embodiment, an audio module (not shown) can be operatively coupled to the fixed-length body having a flexible portion 44 to detect breathing or cries for help. The audio module (not shown) can also be included with a camera head 6. The fixed-length body having a flexible portion 44 can be operatively coupled with the Housing 14 and display module 12 to receive the audio-visual data and/or the audio-visual data can be transmitted remotely via a transmitter 36 that is operatively coupled to the Housing 14. The remotely transmitted data can be transmitted to a remote receiver 40 and/or remotely transmitted to a receiver 40 that is operatively coupled a large stand-alone display module 38, which can display the transmitted video images from the inspection-surveillance system and broadcast audio data. Audio and/or visual data can be remotely transmitted to a secure location used as a command point, or can be transmitted to be assessed by personnel in addition to, or instead of, the user.

It will be appreciated that the open architecture of the inspection-surveillance system addresses the problem of law enforcement or the military purchasing a large number of costly fixed-architecture tools of different types to supply a very large number of facilities, that may not meet the requirements of the field. In light of these problems, the modular inspection-surveillance system of this disclosure accomplishes several important solutions: it provides a system that can be re-configured in the field to provide an immediate solution to user's needs; the inspection-surveillance system is highly cost-efficient because it is modular and flexible, and can be used while maintaining strict budget constraints that often plague public spending; and the components of the inspection-surveillance system can be obtained and interfaced as needed, or purchased as an kit that is easily transported in a waterproof carrier. The inspection-surveillance system can also be employed for civilian use in factories or other large facilities to inspect equipment, vats, assembly lines, and the like, and the facility itself.

It should be understood that the foregoing description is only illustrative of the disclosure, especially because the disclosure relates to an open architecture system. Various alternatives and modifications can be devised by those skilled in the art without departing from the disclosure or the sprit thereof. Accordingly, the present disclosure is intended to embrace all such alternatives, modifications and variances which fall within the scope of the appended claims.

1. A modular inspection-surveillance system which allows reconfiguration of components to gather data as field conditions demand, comprising: a camera head; a body having an electronic cable assembly disposed therein; a display module having a video image viewing screen; a housing having an internal battery; and connectors having electrical and mechanical properties; wherein the components of the modular inspection-surveillance system are operatively coupled via the connectors.

2. A modular inspection-surveillance system of claim 1, wherein the system further comprises an audio device operatively coupled via a connector.

3. A modular inspection-surveillance system of claim 1, wherein the system further comprises a radio frequency transmitter operatively coupled via connectors.

4. A modular inspection-surveillance system of claim 1, wherein the system further comprises a radio frequency receiver that is operatively coupled.

5. A modular inspection-surveillance system of claim 1, wherein the system further comprises a remote display screen module that is remotely positioned with respect to the camera head operatively coupled to the body.

6. A modular inspection-surveillance system of claim 1, wherein the system further comprises a control panel operatively coupled to the housing.

7. A modular inspection-surveillance system of claim 1, wherein the camera head includes a light source.

8. A modular inspection-surveillance system of claim 1, wherein the camera head includes a plurality of lights emitting a plurality of wavelengths.

9. A modular inspection-surveillance system of claim 1, wherein the camera head is sensitive to a plurality of wavelengths.

10. A modular inspection-surveillance system of claim 1, wherein the camera heads are selected from the group consisting of visible light, infrared, ultraviolet spectral response cameras, and combinations thereof.

11. A modular inspection-surveillance system of claim 1, wherein the camera heads are selected from the group consisting of visible light, infrared, ultraviolet illumination cameras and combinations thereof.

12. A modular inspection-surveillance system of claim 1, wherein the system further comprises a multi-mode camera head having at least two different technology modes.

13. A modular inspection-surveillance system of claim 1, wherein the system body is selected from the group consisting of a flexible telescoping body, a telescoping body, a fixed-length rigid body, a fixed-length body having a flexible portion, a rolling trolley, a sliding trolley, a flexible cable and a combination thereof.

14. A modular inspection-surveillance system of claim 1, wherein the system further comprises a harness to be used in combination with components of the modular inspection-surveillance system.

15. A kit of modular components for inspection-surveillance use wherein the components are reconfigured as field conditions require, comprising: a camera head; a body having a cable assembly disposed therein; a display module having a video image viewing screen; a housing having an internal battery; and connectors having electrical and mechanical properties; wherein the components of the modular inspection-surveillance system are operatively coupled via the connectors.

16. A kit of modular components for inspection-surveillance use of claim 15, wherein the camera head has light sources that can emit a plurality of wavelengths.

17. A kit of modular components for inspection-surveillance use of claim 15, wherein the camera head can respond to a plurality of wavelengths.

18. A kit of modular components for inspection-surveillance use of claim 15, further comprising a multi-mode camera head having at least two different video functions.

19. A kit of modular components for inspection-surveillance use of claim 15, further comprising components selected form the group consisting of an audio device, a remote data transmitter, a remote data receiver, a harness, a protective case for transporting the kit, and a combination thereof.

20. A method of covertly inspecting an area comprising: adjusting a camera head's spectral response and illumination bands, attaching the camera head to an operatively coupled body that is flexibly positioned to view the area, and inspecting the area for information.

21. A method of covertly inspecting an area of claim 20, further comprising inspecting the area with a camera head having a spectral response in the infrared wavelengths to detect heat-emitting objects.

22. A method of covertly inspecting an area of claim 21, further comprising inspecting the area with a camera head having illumination bands in the visible spectrum.

23. A method of covertly inspecting an area of claim 22, further comprising inspecting the area with a camera head having illumination bands in the invisible spectrum.

24. A method of covertly inspecting an area of claim 23, further comprising adjusting the body by length and position to allow use from a distance.

25. A method of covertly inspecting an area of claim 24, further comprising transmitting audio and visual data remotely with respect to the positioning of the camera head operatively coupled to the body.
